(19) United States
(12) Patent Application Publication
(10) Pub. No.: US 2021/0133683 A1
(43) Pub. Date: May 6, 2021

(54) PROBABILISTIC SYSTEMS AND ARCHITECTURE TO PREDICT AND OPTIMIZE HIRES

(71) Applicant: Microsoft Technology Licensing, LLC, Redmond, WA (US)

(72) Inventors: Chunzhe Zhang, Sunnyvale, CA (US); Man Yeung, Fremont, CA (US); Sandeep Tiwari, Foster City, CA (US); Hai Jian Guan, San Mateo, CA (US); Nilton Andres Hincapie, San Francisco, CA (US)

(21) Appl. No.: 16/669,336

(22) Filed: Oct. 30, 2019

(51) Int. Cl. G06Q 10/10; G06N 20/00

(52) U.S. Cl. CPC G06Q 10/1053; G06N 20/00

(57) ABSTRACT

Techniques are provided for implementing a probabilistic system and architecture to predict and optimize particular user activity. In one technique, opportunity application data that indicates multiple applications to multiple opportunities is stored. Tracking data that indicates, for each opportunity, a number of reviewer actions with respect to applications to the opportunity is stored. Based on the tracking data, one or more machine learning techniques are used to learn parameters of a model that takes, as input, a number of weighted applications of an opportunity and generates, as output, a prediction of a confirmed hire for the opportunity. A particular opportunity is identified and a first number of reviewer actions with respect to the particular opportunity is determined. A second number of weighted applications for the particular opportunity is generated based on the first number. The second number is input into the model to generate a score for the particular opportunity.

### TECHNICAL FIELD

The present disclosure relates to machine learning and, more particularly, to using machine learning to generate a model that is used to predict hires in an opportunity platform.

### BACKGROUND

The Internet has facilitated the rapid development of modern technologies, including instant communication and coordination regardless of geography. Modern technology has transformed many industries, including talent acquisition. Hirers have access to a virtually limitless pool of geographically dispersed candidates while candidates can be matched to organizations with very little effort. Hirers leverage opportunity platforms to post opportunities while candidates leverage the same opportunity platforms to research those opportunities.

An opportunity platform has an incentive for candidates to get hired for opportunities presented through the platform. This is referred to as the hire rate. The higher the hire rate, the more likely those same candidates are to use the same opportunity platform in the future. Additionally, with good reviews, more candidates are more likely to use the opportunity platform. However, current approaches to attempt to increase the hire rate are deficient. For example, one approach to attempt to increase the hire rate is, for each candidate that visits the opportunity platform, to identify opportunities whose hiring criteria matches attributes of the candidate. While such an approach is useful, some hiring criteria are very broad and, therefore, targets many candidates. Thus, many candidates may be presented with the same opportunity and, as a result, apply to that opportunity. In the end, however, only one applicant might be hired, if at all, leaving many applicants unsatisfied. Because current approaches are unable to predict with any precision whether a particular applicant will be hired for an opportunity, the utility of opportunity platforms is relatively low, causing many candidates to visit multiple opportunity platforms with low success rates.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for predicting hires on an opportunity platform, in an embodiment;

FIG. 2A is chart that depicts a log curve fit of example tracking data;

FIG. 2B is a chart that depicts an example curve through example tracking data using an exponential distribution and machine-learned values for multiple parameters;

FIG. 2C is a chart that depicts an example curve through example tracking data using the exponential distribution and machine-learned values for multiple parameters;

FIG. 3 is a flow diagram that depicts an example process for leveraging opportunity tracking data to predict a confirmed hire for an opportunity, in an embodiment;

FIG. 4 is a chart that depicts a difference between two points on a line that models the relationship between the number of weighted applications and confirmed hire rate, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for predicting and optimizing for hires using a probabilistic system and architecture are provided. In one technique, quality signals pertaining to applications of an opportunity are considered when calculating a score for the opportunity or for a likelihood that the next application to the opportunity will result in a confirmed hire. In a related technology, a model is trained to fit a curve that describes a relationship of (a) a number of weighted applications to (b) an opportunity to a probability that the opportunity will result in a confirmed hire. The number of weighted applications to the opportunity is based on one or more quality metrics associated with the current applications. Thus, the number of weighted applications to the opportunity is based on the number of actual applications to the opportunity.

In a related technique, multiple models are trained and used to generate a probability that a particular application from a particular applicant to a particular opportunity will result in a confirmed hire: one model for opportunities and one model for applicants.

Embodiments offer an accurate, transparent, and intuitive approach to predicting hires. Embodiments account for the ever-changing hiring dynamics by factoring in different segment visibilities, applicant quality, and, optionally, distributions from both the opportunity side and the applicant side. Embodiments incorporate more feedback and quality signals on applications in order to generate more accurate predictions. Prior approaches did not factor in applicant distribution or incorporate multiple signals.

### Definitions

A job poster is an individual, an organization, or a group of individuals responsible for posting information about a job opportunity. A job poster may be different than the entity that provides the job (i.e., the “job provider”). For example, the job poster may be an individual that is employed by the job provider. As another example, the job poster may be a recruiter that is hired by the job provider to create one or more job posting. A job provider may be an individual, an organization (e.g., company or association), or a group of individuals that require, or at least desire, a job to be performed.

A “job” is a task or piece of work. A job may be voluntary in the sense that the job performer (the person who agreed to perform the job) has no expectation of receiving anything in exchange, such as compensation, a reward, or anything else of value to the job performer or another. Alternatively, something may be given to the job performer in exchange for the job performer's performance of the job, such as money, a positive review, an endorsement, goods, a service, or anything else of value to the job performer. In some arrangements, in addition to or instead of the job provider, a third-party provides something of value to the job performer, such as academic credit to an academic institution.

A “job opportunity” is associated with a job provider. If a candidate for a job opportunity is hired, then the particular entity becomes the employer of the candidate. A job opportunity may pertain to full-time employment (e.g., hourly or salaried), part-time employment (e.g., 20 hours per week), contract work, or a specific set of one or more tasks to complete, after which employment may automatically cease with no promise of additional tasks to perform.

A “job seeker” is a person searching for one or more jobs, whether full-time, part-time, or some other type of arrangement, such as temporary contract work. A job seeker becomes an applicant for a job opportunity when the job seeker applies to the job opportunity. Applying to a job opportunity may occur in one of multiple ways, such as submitting a resume online (e.g., selecting an “Apply” button on a company page that lists a job opportunity, selecting an “Apply” button in an online advertisement displayed on a web page presented to the job seeker, or sending a resume to a particular email address) or via the mail, or confirming with a recruiter that the job seeker wants to apply for the opportunity.

A “job application” is a set of data about a job applicant submitted for a job opportunity. A job application may include a resume of the applicant, contact information of the applicant, a picture of the applicant, an essay provided by the applicant, answers to any screening questions, an indication of whether any one of one or more assessment invitations have been sent to the applicant, an indication of whether the applicant completed any of the one or more assessments, and results of any assessments that the applicant completed. A resume or other parts of a job application may list skills, endorsements, and/or qualifications that are associated with the applicant and that may be relevant to the job opportunity.

A “reviewer” is an individual, an organization, or a group of individuals responsible for reviewing applications for one or more job opportunities. A reviewer may be the same entity as the job poster. For example, a reviewer and the corresponding job poster may refer to the same company. Alternatively, a reviewer and the corresponding job poster may be different individuals associated with (or otherwise affiliated with) the same company. In that situation, one person is responsible for posting a job and another person is responsible for reviewing applications. Alternatively, a reviewer may be affiliated with a different party than the job poster. In fact, the job provider, the job poster, and the reviewer may be different parties/companies.

### System Overview

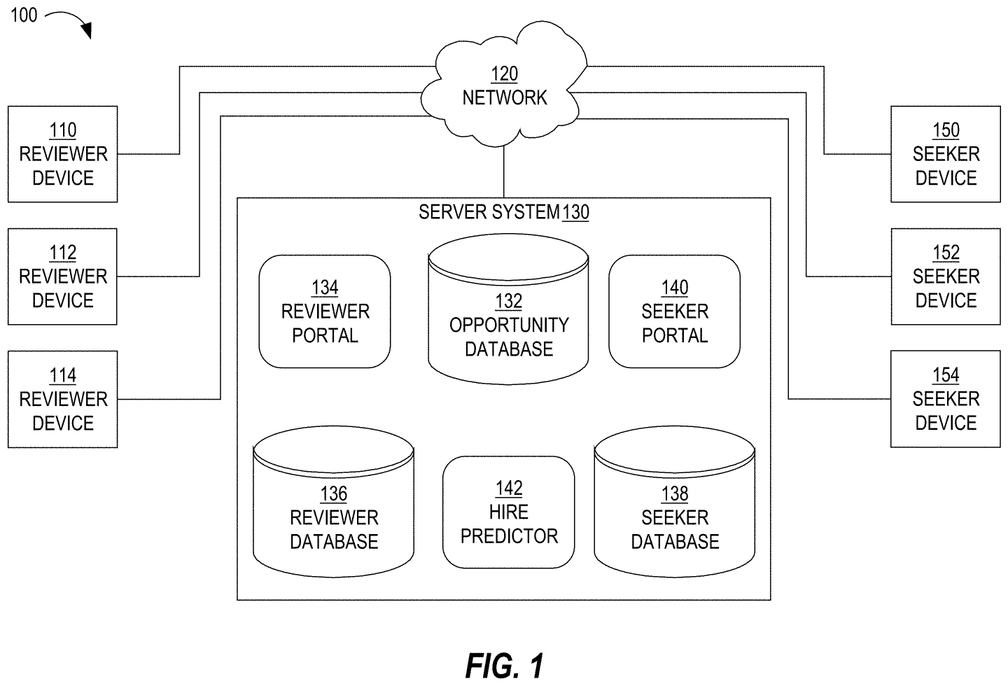

FIG. 1 is a block diagram that depicts an example system 100 for predicting hires on an opportunity platform, in an embodiment. System 100 includes reviewer devices 110-114, a network 120, a server system 130, and seeker devices 150-154. Reviewer devices 110-114 are operated by end-users and send data and/or requests to server system 130 over network 120 (such as a local area network (LAN), wide area network (WAN), or the Internet). Similarly, seeker devices 150-154 are operated by end-users and send data and/or requests to server system 130 over network 120 or another computer network. Examples of devices 110-114 and 150-154 include desktop computers, laptop computers, tablet computers, wearable devices, video game consoles, and smartphones. Also, although only a single network 120 is depicted and described, devices 110-114 and 150-154 may be communicatively connected to server system 130 through different computer networks.

Server system 130 comprises an opportunity database 132, reviewer portal 134, a reviewer database 136, a seeker database 138, a seeker portal 140, and hire predictor 142. Reviewer portal 134, seeker portal 140, and hire predictor 142 may be implemented in software, hardware, or any combination of software and hardware.

Databases 132, 136, and 138 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a LAN, a WAN, or the Internet. Also, each of databases 132, 136, and 138 may be any type of database, such as a relational database, an object database, an object-relational database, a NoSQL database, or a hierarchical database.

Each element of system 100 is described in more detail herein.

### Opportunity Database

Opportunity database 132 comprises data about each of one or more job opportunities. Data about a job opportunity is stored in a record or entry. Data about a job opportunity includes information in the corresponding job posting, such as name of the job provider or employer, a job title, an industry, a description of the opportunity, and skills required for the job. Data about a job opportunity may also include a set of screening questions and one or more assessments for the job opportunity.

A record for a job opportunity may also include (e.g., a link to) data regarding how the corresponding job posting is performing, such as a number of impressions of the job posting (which may be a proxy for the number of seekers who have viewed the job posting), a number of seekers who have selected the job posting, a number of seekers who have applied to the job opportunity, a number of seekers/applicants who have received invitations to take an assessment, a number of seekers/applicants who have accepted invitations to take an assessment, a number of seekers/applicants who have begun an assessment, a number of seekers/applicants who have completed an assessment, and, on a per-applicant basis, an indication of which of these actions (e.g., invited, began, completed) have been performed relative to the assessment.

In an embodiment, a record for a job opportunity indicates a number of applicants that are already rated as a good fit, a maybe, or not a fit. Such a rating may be based on how well the corresponding job posting attributes match the applicant's attributes and whether the applicant has successfully completed an assessment for the job opportunity. For example, the following factors may increase a rating of an applicant, if the job title of the job posting matches the job title of the applicant, a high percentage of the skills listed in the job posting match (or nearly match) skills associated with (e.g., listed in a profile of) the applicant, and a relatively high score (e.g., in the 90^{th} percentile) on an assessment.

In an embodiment, a record for a job opportunity indicates various stages in which applicants are in the hiring pipeline, such as invited to a telephone interview, scheduled a telephone interview, completed a telephone interview, invited to an onsite interview, scheduled an onsite interview, and completed an onsite interview. For example, the number of applicants that have been invited to each type of interview may be generated and stored in the record, etc. Those applicants that have scheduled or completed an onsite interview may be considered close to hiring.

### Reviewer Device

Reviewer devices 110-114 interact with server system 130 over network 120 through reviewer portal 134. For example, reviewer portal 134 receives login credentials from a reviewer device, identifies an account associated with the login credentials, and presents data based on the identified account. A reviewer device submits requests to server system 130 via reviewer portal 134. Requests may be generated and submitted in response to user input to a user interface displayed on the reviewer device, such as selection of a graphical button. The reviewer device executes a client application, which may be a native application or a web application that executes within a web browser, such as Internet Explorer, Mozilla Firefox, and Google Chrome.

The client application displays the user interface and includes selectable options for navigating and presenting the corresponding opportunity information, such as one or more job postings associated with the account, and, for each job posting, one or more available assessments for that job posting, a total number of applicants (of the job posting) that have received an assessment, which applicants have received an assessment, which applicants have started but not completed an assessment, which applicants have completed an assessment, results of an assessment from a particular applicant, which applicants have received an invitation to interview, which applicants have accepted or declined to an interview invitation, which applicants have had an interview, whether a final decision has been made for each applicant and, if so, what that decision is.

### Reviewer Database

Reviewer database 136 comprises data about operators (referred to as “reviewers”) of reviewer devices 110-114. Such data might not be visible to the operators/reviewers. Instead, such data is used by hire predictor 142. Reviewer portal 134 records activities performed by a reviewer, such as a number of page views of individual applicants, when each such page view occurred, and decisions that the reviewer made for each applicant, such as interview, decline, or wait. Reviewer portal 134 may also record, in reviewer database 136, how frequently a reviewer reviews applicants and, when a review session is conducted by a reviewer, a number of applicants that the reviewer reviews.

### Seeker Device

Seeker devices 150-154 interact with server system 130 over network 120 through seeker portal 140. Seeker devices 150-154 may be similar to reviewer devices 110-114. For example, seeker portal 140 receives login credentials from a seeker device, identifies an account associated with the login credentials, and presents data based on the identified account. A seeker device submits requests to server system 130 via seeker portal 140. Requests may be generated and submitted in response to user input to a user interface displayed on the seeker device, such as selection of a graphical button. The seeker device executes a client application, which may be a native application or a web application that executes within a web browser, such as Internet Explorer, Mozilla Firefox, and Google Chrome.

The client application displays the user interface and includes selectable options for navigating and presenting the corresponding opportunity information, such as one or more job opportunities that the seeker viewed, one or more job opportunities to which the seeker applied and, for each such applied opportunity, an indication of whether the seeker received an assessment invitation, whether the seeker accepted the assessment invitation, whether the seeker started the assessment (if accepted), whether the seeker completed the assessment (if begun), a score/results of the assessment (if available), whether the reviewer has acknowledged or reviewed results of the assessment, and whether the seeker has been invited to interview (such as a phone interview or an onsite interview) and/or some other post-assessment invitation.

### Seeker Database

Seeker database 138 comprises data about operators (referred to as “seekers”) of seeker devices 150-154. Such data might not be visible to the operators/seekers. Instead, such data is used by hire predictor 142. Seeker portal 140 records activities performed by a seeker, such as a number of page views of individual opportunities, when each such page view occurred, whether the seeker applied to a presented opportunity, whether the seeker was presented with an assessment invitation, whether the seeker accepted an assessment invitation, whether the seeker started an assessment, whether the seeker completed an assessment, a score or result of a completed assessment, and whether the seeker has followed up with a job provider or reviewer of a completed assessment.

Seeker portal 140 may also record, in seeker database 138, how frequently a seeker applies to opportunities, how frequently the seeker reviews the status of opportunities for which the seeker has applied, how frequently the seeker is reviewing new opportunities (or opportunities for which the seeker has not yet applied), and, when such review sessions are conducted by a seeker, a number of opportunities that the seeker reviews. Seeker portal 140 (or another component, such as hire predictor 142) may also calculate a frequency or rate of applying to and/or reviewing opportunities per unit of time (e.g., number of opportunities applied to per ten minutes) and a rate of change in pace of applying or reviewing, such as 10 opportunities applied to per hour on day 1 and 15 opportunities applied to per hour on day 8.

### Confirmed Hire

One way to detect that a seeker has been hired at a particular organization is detecting an employer name change in the seeker's profile maintained in a profile database (not depicted) to which server system 130 has access. A seeker might change his/her profile (a) immediately after accepting an offer, (b) sometime around his/her start date, or (c) potentially many months after his/her start date. Sometimes, a seeker never updates his/her profile, in which case a hire of that seeker cannot be confirmed.

In an embodiment, server system 130 associates a user's hire with a particular organization with a particular opportunity associated with the particular organization. One way to determine to make the association is determining that the user applied to the particular opportunity, as indicated in opportunity database 132. Such a determination may be inferred if the job title listed in the particular opportunity is the same as the job title listed in the seeker's profile, which may have been updated in addition to the employer name in the seeker's profile. Such a scenario might occur if a poster for the particular organization posted the particular opportunity on other opportunity platforms separate from server system 130.

### Quality Signals

In an embodiment, quality of an application is taken into account when training a model to predict hires. Different opportunities are likely to have different probabilities of success (i.e., resulting in a hire) if applications to the opportunities have different quality signals, even though the number of applications of each opportunity is the same. For example, both opportunity A and opportunity B have ten applications each. However, for opportunity A, in three of those ten applications, messages were exchanged between the reviewer and the corresponding applicants; in five of those ten applications, the reviewer viewed profiles of the corresponding applicants; and in two of those ten applications, the reviewer did not perform any action with respect to the applications. In contrast, for opportunity B, in five of those ten applications, messages were exchanged between the reviewer and the corresponding applicants; in two of those ten applications, the reviewer viewed profiles of the corresponding applicants; and in three of those ten applications, the reviewer did not perform any action with respect to the applications. Without tracking these types of interactions (and, optionally, non-interactions) and analyzing hire rates associated with previous applications, it is not clear whether opportunity A or opportunity B has a higher probability of a hire.

Examples of types of quality signals of an application include reviewer actions with respect to the application/applicant, a lack of any interaction by the reviewer of the application, and whether the application meets a minimum quality level, such as whether the applicant satisfies hiring criteria of the corresponding opportunity or whether the applicant and the corresponding opportunity are associated with the same country and the same job title.

Examples of specific quality signals of an application include a positive/negative rating from the reviewer, the reviewer downloading a resume of the applicant, a manual rejection by the reviewer, an automated rejection (e.g., any applications outside a particular country are automatically rejected), a view by the reviewer of a profile of the applicant, a message sent by the reviewer to the applicant, and a reply by the applicant to the message. Each of these actions is a different type of action. One or more of such actions may be stored in opportunity database 132, reviewer database 136, and/or seeker database 138.

In an embodiment, tracking data is generated and stored for each application pertaining to one or more quality signals. The tracking data may be stored in opportunity database 132, reviewer database 136, and/or seeker database 138. The tracking data may extend into the distant past or may be maintained for a certain period of time (e.g., a year) before being automatically purged/deleted. Based on the tracking data (or a portion thereof), a weight is calculated for each quality signal, such as each action type. For example, 0.5% of applications that involved messages exchanged between reviewer and applicant resulted in a confirmed hire, 0.31% of applications that involved the reviewer viewing a profile of the application resulted in a confirmed hire, and 0.05% of applications where the reviewer performed no action relative to the applicant or application resulted in a confirmed hire. These percentages may be used directly as weights or may be scaled or normalized so that, for example, the lowest percentage has a weight of one.

In a related embodiment, a hierarchy of quality signals is used in cases where a single application has multiple quality signals, such as a profile view and a messaged interaction. For example, if a single application had a messaged interaction and a profile view, because message interactions are a stronger signal than profile views according to the hierarchy, then a weight associated with the messaged interaction is used for the single application.

Once weights for different quality signals are computed, a total number of weighted applications for an opportunity (that has received one or more applications) may be computed. For example:

Total Weighted Applications=7.64*(# of applications with a message exchanged)+4.74*(# of applications with a profile view by the reviewer)+0.76*(# of applications that has no interactions with the reviewer)

Thus, different opportunities with the same number of applications are likely to be associated with different values for total weighted applications because each opportunity is likely to have a different mix of quality signals and/or different magnitude of the same quality signals.

In a related embodiment, weights for the different quality signals are re-computed regularly (e.g., weekly or monthly).

### Probabilistic Modeling

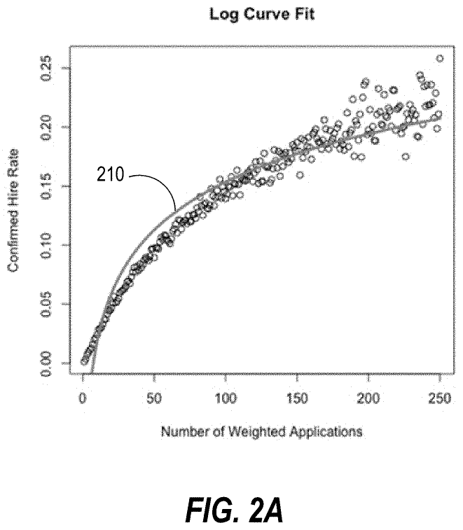

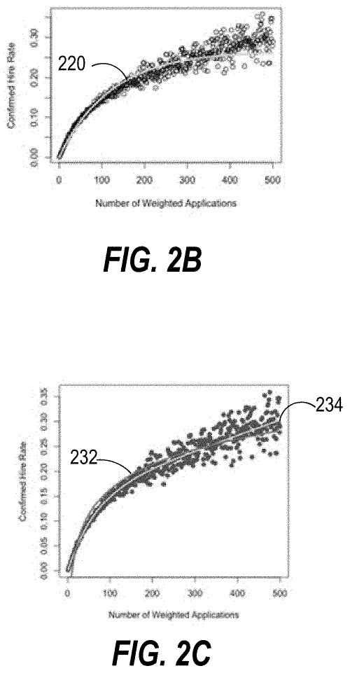

In an embodiment, a model is generated automatically that describes the relationship between the number of weighted applications and confirmed hires rate. A challenge is that a simple log curve approach does not capture the correct trend. FIG. 2A is chart that depicts a log curve fit of example tracking data. For small values of weighted applications, line 210 underestimates confirmed hires, for a significant mid-range of values for weighted applications, line 210 overestimates confirmed hires, and for relatively high values of weighted applications, line 210 again underestimates confirmed hires.

The task, therefore, may be formulated using a probabilistic approach. X represents the number of weighted applications received for an opportunity, F(X) represents the probability of finding a confirmed hire for the opportunity, and p represents the probability of a random unit of a weighted application being qualified for hire. Given X weighted applications, the probability of finding a hire is:

F(X)=1−(1−p)^{X}

which is the cumulative distribution function of geometric distribution. As the number of weighted applications increase, the value of F(X) increases. Because the number of weighted applies is a continuous number, the continuous counterpart of geometric distribution (i.e., exponential distribution) should be used to model F(X). The following formula describes the cumulative distribution function of exponential distribution:

F(X)=1−e^{-λX}

In an embodiment, additional factors are considered when learning function F(X) since the probability of finding a confirmed hire for an opportunity is far from 100%, even with more than 1,000 applications. Examples of such additional factors include competition loss, profile updating loss, and multi job overcounting. “Competition loss” refers to the fact that an opportunity can be posted on multiple opportunity platforms. Thus, even with many applications on one opportunity platform, a poster might still hire an applicant through another opportunity platform. “Profile updating loss” refers to the fact that many applicants who are hired through opportunity platform do not update their respective profiles, to which the opportunity platform has access. Multi job overcounting refers to the fact that a seeker applies to multiple opportunities within the same organization and is hired to one of those opportunities. Each of those opportunities will be marked as having a confirmed hire.

Based on these additional factors that are related to the imperfection of the confirmed hire rate, F(X) may become the following:

F(X)=R(Overcounting)*P(Updating Prof ile|Hire)*P(Hired|Qualified)*P(Qualified|X)

If a constant rate is assumed for the imperfection in the confirmed hire rate, then the following function may be used to fit the curve:

F(X)=α*(1−e^{-λ*S})

The following objective function (minimizing the weighted sum of squares) may be used to find values for parameters α and λ

min_{{α,λ}}ΣN(X)*(Y−α*(1−e^{-λ*X}))²

where N(X) represents the number of observations at X, and Y represents the confirmed hire rate associated with X over a period of time, such as the last month. In an embodiment, the objective function may be executed regularly (e.g., weekly or monthly) to learn new values for the different parameters. The resulting model is stored in or made accessible to hire predictor 142.

FIG. 2B is a chart that depicts an example curve through example tracking data using the exponential distribution and machine-learned values for the above two parameters. Compared to line 210, line 220 fits the tracking data better.

### Popular Opportunities

Based on observations, the line/curve produced by machine-learned values of α and λ may underestimate the confirmed hire rate for higher values of X, such as X>300. This may be due to similar factors outlined above but with respect to opportunities that have had many applications (i.e., popular opportunities). For example, regarding profile updating loss, applicants to popular opportunities may be more likely than applicants to less popular opportunities to update their respective profiles. Regarding competition loss, popular opportunities are less likely to be posted in multiple opportunity platforms. However, with respect to multi job overcounting, popular opportunities tend to have a higher overcount rate than less popular opportunities.

In an embodiment, to account for these factors for popular opportunities, another parameter is added to F(X) and learned during the machine learning process. This other parameter allows the “imperfection” to increase as the number of weighted applications increases. For example:

F(X)=α*(1+(X/b))*(1−e^{-λ*X})

Alternatively, instead of using a machine learning process to learn a value for b, the value of b may be manually established, for example, by a developer of the model.

FIG. 2C is a chart that depicts an example curve through example tracking data using the exponential distribution and values for the three parameters, the values of at least two of which are machine-learned. Compared to line 220, line 230 fits the tracking data better at higher values of X

### Leveraging the Model

The trained model may be used in one or more ways. For example, given an opportunity, a probability of a confirmed hire resulting from the opportunity may be computed. Such a probability may be computed for each of multiple opportunities. For example, hire predictor 142 is invoked for each opportunity for which the probability is to be computed. As another example, an aggregated output from the trained model may be used as a key metric to monitor performance of an opportunity platform. As a further example, output from the trained model may be used as a metric to evaluate changes (to the opportunity platform) in AB testing.

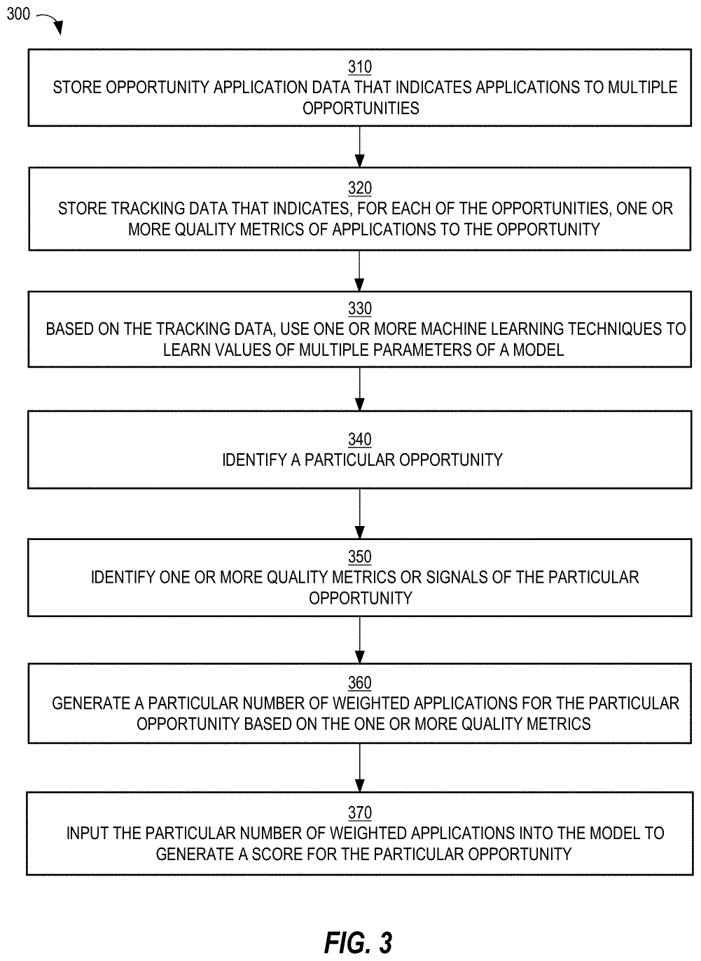

FIG. 3 is a flow diagram that depicts an example process 300 for leveraging opportunity tracking data to predict a confirmed hire for an opportunity, in an embodiment. Process 300 may be implemented by server system 130.

At block 310, opportunity application data that indicates a plurality of applications to a plurality of opportunities is stored. For each opportunity, there may be tens, hundreds, or thousands of applications, each corresponding to a different applicant. Such opportunity application data may be stored in opportunity database 132.

At block 320, tracking data is stored that indicates, for each of the opportunities, one or more quality metrics of applications to the opportunity. Examples of quality metrics include a number of certain types of reviewer actions with respect to the applications, such as number of applications in which a reviewer viewed a profile of the corresponding applicant, number of applications in which a review downloaded a resume of the corresponding applicant, reviewer rating of each rated application, and number of applicants in which a reviewer sent a message to the corresponding applicant.

At block 330, based on the tracking data, one or more machine learning techniques are used to learn values of multiple parameters of a model that takes, as input, a number of weighted applications of an opportunity, and generates, as output, a prediction of a confirmed hire for the opportunity.

At block 340, a particular opportunity is identified. Block 340 may be performed in response to receiving a request to generate a set of opportunity recommendations. Such a request may be received in response to a user, through his/her computing device, visiting a website affiliated with (e.g., hosted by) server system 130. Alternatively, block 340 may be performed in response to one or more other signals, such as determination to automatically provide the set of opportunity recommendations to a particular seeker on a regular basis (e.g., weekly).

The opportunity identified in block 340 may be one upon which the model was generated. Alternatively, the identified opportunity is one upon which the model has not been generated. For example, the identified opportunity may have been created after the model was generated.

At block 350, one or more quality metrics or signals are identified for the particular opportunity. For example, a number of reviewer actions of one or more types with respect to the particular opportunity is/are identified. For example, a first number of applications for the particular opportunity are identified in which the reviewer sent a message (e.g., email) to the applicant, a second number of applications for the particular opportunity are identified in which the reviewer viewed a profile of the applicant, and a third number of applications for the particular opportunity are identified in which the reviewer performed no action on the application.

At block 360, a particular number of weighted applications for the particular opportunity is generated based on the one or more quality metrics. For example, each type of quality metric is associated with a weight and the number of applications associated with that type of quality metric is combined with (e.g., multiplied by) that weight to generate a weighted value. If there are multiple quality metrics, then multiple weighted values are computed and may be summed to generate the particular number.

At block 370, the particular number of weighted applications is input into the model to generate a score for the particular opportunity. For example, the particular number is X and that value is input into F(X)=α*(1+(X/b))*(1−e^{-λ*X}), where values for α, b, and λ are known. Block 370 may be implemented by hire predictor 142.

Blocks 340-370 may be repeated for additional opportunities and, as a result, a score is generated for each of those opportunities. Process 300 may proceed by ranking the opportunities based on the generated scores (e.g., opportunities with lower scores are ranked higher), or other scores generated based on those scores, where an example of such generation is described in more detail below.

### Using the Trained Model to Generate a Prediction for a Specific Application

In an embodiment, the trained model is used to generate a prediction for a specific application to a particular opportunity. Such a prediction allows multiple opportunities to be considered and ranked prior to presenting any of the opportunities to a user, such as a job seeker. The higher the likelihood that applying to a particular opportunity will result in a hire, the higher that particular opportunity will be ranked relative to other opportunities.

In order to use the trained model to generate the prediction, two points on the curve produced by the trained model are identified: (1) one point corresponding to a weighted number of applications to an opportunity before a particular application; and (2) one point corresponding to a weighted number of applications to the opportunity after the particular application (or if the user applies to the opportunity). Each point indicates a different confirmed hire rate. A difference between the two confirmed hire rates indicates a likelihood that the particular application will result in a confirmed hire and not any of the other applications.

Another way to define the likelihood of a particular application resulting in a confirmed hire using the trained model is with the following formula:

I=P(All of this job's previous applications are not hired)*P(this application is a confirmed hire)

˜P(All of this job's previous applications are not hired)*p*wⱼ

where “˜” means approximately equal to, p is a probability of a random unit of application being qualified for hire (and may be assumed to be a constant) and wⱼ is the particular application's weight. P(All of this job's previous applications are not hired) is determined by looking at the current number of weighted applications for the opportunity and then finding the point on the curve and subtracting that value from 1. The value of p may be calculated based on tracking data by dividing all confirmed hires (that occurred or were detected in a first period of time) by the number of applications (e.g., that occurred in a second period of time). For a given segment, p is assumed to be the same for each unit of application on the opportunity side and the applicant side.

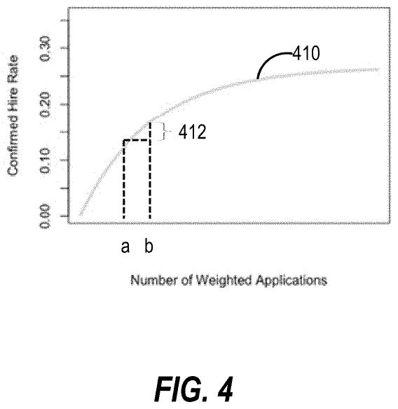

FIG. 4 is a chart that depicts a difference 412 between two points on line 410 that models the relationship between the number of weighted applications and confirmed hire rate, in an embodiment. Point a refers to a first number of weighted applications and b refers to a second number of weighted applications and may be equal to a+w, where w is the number of weighted applications of a particular application that may or may not have occurred yet. Difference 412 reflects the likelihood that the particular application will result in a confirmed hire. Difference 412 is associated with one opportunity and may be used to rank that one opportunity relative to other candidate opportunities.

Process 300 may be extended to include blocks for computing I, such as a block to determine P(All of this job's previous applications are not hired), a block to determine p, a block to determine wⱼ, and a block for computing I based on P(All of this job's previous applications are not hired), p, and wⱼ. Another block may be included to determine, based on that I, whether to present an opportunity that corresponds to j. That block may involve comparing similarly-generated Is for other opportunities and ranking all the opportunities based on their respective Is.

### Opportunity-Oriented Model and Applicant-Oriented Model

In an embodiment, two models are trained: an opportunity-oriented model and an applicant-oriented model. The opportunity-oriented model is trained based on tracking data on a per-opportunity basis and the applicant-oriented model is trained based on tracking data on a per-applicant-basis. Thus, not only are different opportunities associated with a different number of weighted applications, different applicants are associated with a different number of weighted applications. In order to generate a number of weighted applications for a particular applicant, quality signals of each application that the particular applicant submitted are identified and weights for those quality signals are determined. From empirical calculations, the weights of the quality signals on the applicant side are different than, but similar to, the corresponding weights of the quality signals on the job side.

The parameters of each model are likely to be different. An example of an opportunity-oriented model is the following:

F(X)=0.1378*(1+(X/500))*(1−e^{-0.0206*X})

This model represents the relationship between the number of weighted applications and confirmed hire rates for opportunities. An example of an applicant-oriented model is the following:

F(X)=0.0579*(1+(X/500))*(1−e^{-0.0245*X})

This model represents the relationship between the number of weighted applications and confirmed hire rates for applicants. In each of these models, the parameter for popular opportunities is manually determined instead of learned through a machine learning process. Also, while a particular opportunity might have received many applications, a particular seeker might have applied to few if any applications. Conversely, while a particular seeker might have applied to many applications, a particular opportunity might have received few applications.

In an embodiment, the likelihood of a particular application resulting in a confirmed hire using both trained models is with the following equation:

Iⱼₐ=P(All of this job's previous applications are not hired)*P(All of this applicant's previous applications are not hired)*P(this application is a confirmed hire)

˜P(All of this job's previous applications are not hired)*P(All of this applicant's previous applications are not hired)*p*weight=

P(All of this job's previous applications are not hired)*P(All of this applicant's previous applications are not hired)*p*(wⱼ*w_{α}))^{1/2}

where “˜” means approximately equal to, p is a probability of a random unit of application being qualified for hire (and may be assumed to be a constant), wⱼ is the particular application's weight on the job curve, and w_{α} is the particular application's weight on the applicant's curve.

With this definition of increment, a probability of confirmed hire (CH) of a particular application for a particular opportunity (j) from a particular applicant (a) may be defined as follows:

CH=ΣI_{j,α}=(1/p)*Σ((Iⱼ*I_{α}))/(wⱼ*w_{α})^{1/2})

In a related embodiment, one or more multipliers are added to the above equation. One potential multiplier is O, which represents a confirmed hire overcounting multiplier (each job could receive more than 1 confirmed hire). Such overcounting is different than the overcounting described in relation to the a parameter in that this overcounting addresses the scenario where there is more than one confirmed hire for an opportunity, whereas the previous overcounting address the scenario where an applicant applied to two similar positions and was hired for one of them, but it is not clear which position for which the applicant was hired. Another potential multiplier is M, which represents a mature level multiplier. M accounts for the fact that the training data might not be perfect as a result of some users taking a long time to update their respective profiles to indicate a change in employer, which is one way to track confirmed hires. Thus, the above equation becomes:

$$CH = O * M * {\sum }_{a , j} {I}_{ja} = O * M * \frac{1}{p} * {\sum }_{a , j} \frac{{I}_{a} * {I}_{j}}{\sqrt{{w}_{j} * {w}_{a}}}$$

With this formula, c is defined as:

$$: c = O * M * \frac{1}{p}$$

where c may be estimated using historical data, i.e., confirmed hire data from a previous time period (e.g., the last year or the last month):

$$\hat{c} = CH / {\sum }_{a , j} \frac{{I}_{a} * {I}_{j}}{\sqrt{{w}_{j} * {w}_{a}}}$$

The estimated value of c may be computed regularly, such as weekly or monthly.

The probability of a confirmed hire for a particular time period (e.g., the most recent year or month) may then be defined as:

$$PCH = \hat{c} * {\sum }_{a , j} \frac{{I}_{a} * {I}_{j}}{\sqrt{{w}_{j} * {w}_{a}}}$$

where the summation is for all applications that occurred in the particular time period.

The probability of a confirmed hire for an individual application may then be defined as:

$$P C H = \hat{c} * \frac{{I}_{a} * {I}_{j}}{\sqrt{{w}_{j} * {w}_{a}}}$$

In order to calculate PCH, both models are leveraged to compute I_{α} and Iⱼ, respectively.

### Segments

In an embodiment, opportunities in opportunity database 132 are grouped according to segment. Each opportunity is assigned to (e.g., only) one of multiple segments. Each segment may correspond to a different product (which may have a different pricing model than other products) or correspond to a source and/or a type of opportunity. Example segments include online onsite, field onsite, offsite non-wrapping, offsite wrapping, and fee. A posting for an opportunity that is created by a poster interacting with server system 130 (i.e., “online”) and that is presented to seekers who visit a website hosted by server system 130 (i.e., “onsite”) is considered an online onsite posting. A posting for an opportunity that is created by representatives of server system 130 and that is presented to seekers who visit a website hosted by server system 130 (i.e., onsite) is considered a field onsite posting. A posting for an opportunity that is created through a system or platform that is different than server system 130 (i.e., offsite) where the posting is scraped or copied by a process affiliated with server system 130 and then posted onsite is considered an offsite wrapping posting. A posting that is manually posted by an opportunity poster, but where applicants are directed to a third-party (e.g., company) website or application tracking system (ATS) to submit an application to the opportunity is considered an offsite non-wrapping posting. A posting for an opportunity that does not require the poster to provide renumeration to server system 130 for presenting the posting is considered a free posting. Additionally, an “onsite” posting may be one that includes a link or reference to a web page hosted by server system 130 (or an affiliated system) while an “offsite” posting may be one that includes a link to a web page that is hosted offsite or by a system that is not affiliated with server system 130, such as a system that is owned and maintained by the organization of the poster.

In an embodiment, a different probabilistic model is trained for each segment. Thus, first tracking data pertaining to opportunities of a first segment is used to train a first model for that segment and second tracking data pertaining to opportunities of a second segment is used to train a second model for that segment. Thus, different parameter values for F(X) are learned for different segments. An advantage of this approach is that the model has improved accuracy over a model that is trained based on all opportunities, regardless of segment affiliation. Indeed, opportunities from some segments may have very different quality signals compared to opportunities from other segments.

In a related embodiment, two models are trained for each segment: an opportunity-oriented model and an applicant-oriented model.

Other example segments include country-based segments (e.g., one segment for opportunities in the U.S. and another segment for opportunities in Europe), job function-based segments, industry-based segments (e.g., one segment for the technology industry and another segment for the finance industry), job seniority-based segments, and SMB-based segments.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

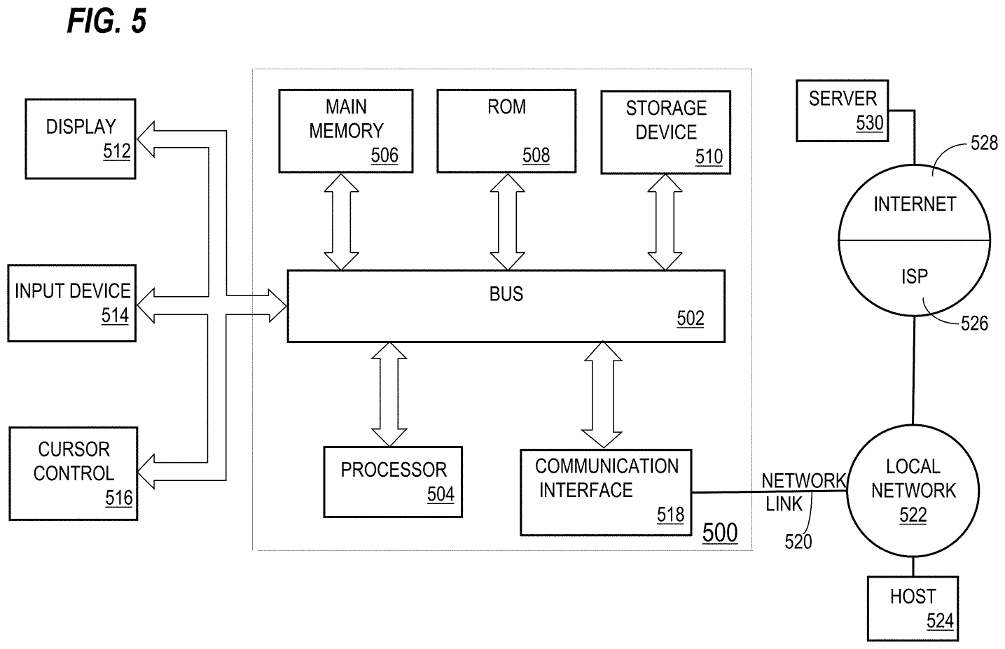

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing opportunity application data that indicates a plurality of applications to a plurality of opportunities;
storing tracking data that indicates, for each opportunity of the plurality of opportunities, a number of reviewer actions with respect to applications to said each opportunity;
based on the tracking data, using one or more machine learning techniques to learn a plurality of parameters of a model that takes, as input, a number of weighted applications of an opportunity, and generates, as output, a prediction of a confirmed hire for the opportunity;
identifying a particular opportunity;
determining a particular number of reviewer actions with respect to the particular opportunity;
generating a particular number of weighted applications for the particular opportunity based on the particular number of reviewer actions;
inputting the particular number of weighted applications into the model to generate a score for the particular opportunity;
wherein the method is performed by one or more computing devices.

2. The method of claim 1, wherein the score is a first score, the method further comprising:
generating a second number of weighted applications for the particular opportunity based on the particular number of weighted applications and a subsequent application;
inputting the second number of weighted applications into the model to generate a second score;
based on the first score and the second score, generating a particular prediction of a confirmed hire for the subsequent application.

3. The method of claim 2, wherein the model is a first model, the method further comprising:
identifying a particular applicant;
generating a value that is based on a number of applications submitted by the particular applicant;
inputting the value into a second model, that is different than the first model, to generate a third score for the particular applicant;
wherein generating the particular prediction is also based on the third score.

4. The method of claim 1, wherein:
the tracking data indicates, for the particular opportunity, a first number of reviewer actions of a first action type with respect to the particular opportunity and a second number of reviewer actions of a second action type with respect to the particular opportunity;
the first action type is different than the second action type;
generating the particular number of weighted applications is based on the first number of reviewer actions of the first action type and the second number of reviewer actions of the second action type.

5. The method of claim 4, wherein the first action type includes one of message interaction between reviewer and applicant, profile view by reviewer, or rating of applicant by reviewer.

6. The method of claim 4, further comprising:
based on the tracking data, for each action type of a plurality of action types that includes the first action type and the second action type, computing a weight for said each action;
wherein generating the particular number of weighted applications for the particular opportunity comprises:
for each action type of the plurality of action types, computing a weighted action value for said each action type;
wherein the particular number of weighted applications is based on the weighted action value of each action type of the plurality of action types.

1. hod of claim 1, further comprising:
receiving a content request for one or more content items;
in response to receiving the content request:
identifying a subset of the plurality of opportunities that includes the particular opportunity and a second opportunity that is different than the particular opportunity;
for each opportunity in the subset, generating a different score for said each opportunity using the model;
selecting one or more opportunities from the subset of the plurality of opportunities based on the score generated for each opportunity in the subset;
causing data about the one or more opportunities to be transmitted over a computer network to a computing device for presentation.

8. The method of claim 1, wherein a first parameter of the plurality of parameters accounts for an imperfection, in predictions generated by the model, that is due to:
profile updating loss due to one or more applicants not updating their respective profiles after becoming hired in response to applications to opportunities,
competition loss due to posters finding applicants from other hiring platforms, or
multi-opportunity overcounting due to an applicant applying to multiple opportunities at the same organization and becoming hired at one of them while each of the multiple opportunities being marked as a confirmed hire.

9. The method of claim 8, wherein a second parameter of the plurality of parameters allows for the imperfection in the confirmed hire prediction to increase as the number of weighted applications increases.

10. The method of claim 1, wherein:
the opportunity application data is first opportunity application data;
the plurality of applications is a first plurality of applications;
the plurality of opportunities is a first plurality of opportunities that pertain to a first segment that is different than a second segment;
the tracking data is first tracking data;
the model is a first model;
the method further comprising:
storing second opportunity application data that indicates a second plurality of applications to a second plurality of opportunities that pertain the second segment;
storing second tracking data that indicates, for each opportunity of the second plurality of opportunities, a second number of reviewer actions with respect to applications to said each opportunity;
based on the second tracking data, using the one or more machine learning techniques to learn a second plurality of parameters of a second model that is different than the first model;
using the second model for opportunities that pertain to the second segment.

11. A method comprising:
storing opportunity application data that indicates a number of applications to each opportunity of a plurality of opportunities and a number of opportunities to which each user of a plurality of users has applied;
storing quality data that indicates, for each opportunity of the plurality of opportunities, one or more quality metrics associated with said each opportunity;
determining a first number of applications to a particular opportunity of the plurality of opportunities;
determining first quality data associated with the particular opportunity;
determining a second number of applications that a particular user of the plurality of users has submitted.
based on the first number, the second number, and the first quality data, determining whether to present data about the particular opportunity to the particular user;
wherein the method is performed by one or more computing devices.

12. One or more storage media storing instructions which, when executed by one or more processors, cause:
storing opportunity application data that indicates a plurality of applications to a plurality of opportunities;
storing tracking data that indicates, for each opportunity of the plurality of opportunities, a number of reviewer actions with respect to applications to said each opportunity;
based on the tracking data, using one or more machine learning techniques to learn a plurality of parameters of a model that takes, as input, a number of weighted applications of an opportunity, and generates, as output, a prediction of a confirmed hire for the opportunity;
identifying a particular opportunity;
determining a particular number of reviewer actions with respect to the particular opportunity;
generating a particular number of weighted applications for the particular opportunity based on the particular number of reviewer actions;
inputting the particular number of weighted applications into the model to generate a score for the particular opportunity.

13. The one or more storage media of claim 12, wherein the score is a first score, wherein
the instructions, when executed by the one or more processors, further cause:
generating a second number of weighted applications for the particular opportunity based on the particular number of weighted applications and a subsequent application;
inputting the second number of weighted applications into the model to generate a second score;
based on the first score and the second score, generating a particular prediction of a confirmed hire for the subsequent application.

14. The one or more storage media of claim 13, wherein the model is a first model, wherein the instructions, when executed by the one or more processors, further cause:
identifying a particular applicant;
generating a value that is based on a number of applications submitted by the particular applicant;
inputting the value into a second model, that is different than the first model, to generate a third score for the particular applicant;
wherein generating the particular prediction is also based on the third score.

15. The one or more storage media of claim 12, wherein:
the tracking data indicates, for the particular opportunity, a first number of reviewer actions of a first action type with respect to the particular opportunity and a second number of reviewer actions of a second action type with respect to the particular opportunity;
the first action type is different than the second action type;
generating the particular number of weighted applications is based on the first number of reviewer actions of the first action type and the second number of reviewer actions of the second action type.

16. The one or more storage media of claim 15, wherein the first action type includes one of message interaction between reviewer and applicant, profile view by reviewer, or rating of applicant by reviewer.

17. The one or more storage media of claim 15, wherein the instructions, when executed by the one or more processors, further cause:
based on the tracking data, for each action type of a plurality of action types that includes the first action type and the second action type, computing a weight for said each action;
wherein generating the particular number of weighted applications for the particular opportunity comprises:
for each action type of the plurality of action types, computing a weighted action value for said each action type;
wherein the particular number of weighted applications is based on the weighted action value of each action type of the plurality of action types.

18. The one or more storage media of claim 12, wherein the instructions, when executed by the one or more processors, further cause:
receiving a content request for one or more content items;
in response to receiving the content request:
identifying a subset of the plurality of opportunities that includes the particular opportunity and a second opportunity that is different than the particular opportunity;
for each opportunity in the subset, generating a different score for said each opportunity using the model;
selecting one or more opportunities from the subset of the plurality of opportunities based on the score generated for each opportunity in the subset;
causing data about the one or more opportunities to be transmitted over a computer network to a computing device for presentation.

19. The one or more storage media of claim 12, wherein a first parameter of the plurality of parameters accounts for an imperfection, in predictions generated by the model, that is due to:
profile updating loss due to one or more applicants not updating their respective profiles after becoming hired in response to applications to opportunities,
competition loss due to posters finding applicants from other hiring platforms, or
multi-opportunity overcounting due to an applicant applying to multiple opportunities at the same organization and becoming hired at one of them while each of the multiple opportunities being marked as a confirmed hire.

20. The one or more storage media of claim 12, wherein:
the opportunity application data is first opportunity application data;
the plurality of applications is a first plurality of applications;
the plurality of opportunities is a first plurality of opportunities that pertain to a first segment that is different than a second segment;
the tracking data is first tracking data;
the model is a first model;
the instructions, when executed by the one or more processors, further cause:
storing second opportunity application data that indicates a second plurality of applications to a second plurality of opportunities that pertain the second segment;
storing second tracking data that indicates, for each opportunity of the second plurality of opportunities, a second number of reviewer actions with respect to applications to said each opportunity;
based on the second tracking data, using the one or more machine learning techniques to learn a second plurality of parameters of a second model that is different than the first model;
using the second model for opportunities that pertain to the second segment.
